(19) United States
(12) Patent Application Publication
(10) Pub. No.: US 2023/0286782 A1
(43) Pub. Date: Sep. 14, 2023

(54) DYNAMIC LIFT-OFF CONTROL DEVICE AND MOBILE CRANE

(71) Applicant: TADANO LTD., Kagawa (JP)

(72) Inventor: Shohei NAKAOKA, Kagawa (JP)

(73) Assignee: TADANO LTD., Kagawa (JP)

(21) Appl. No.: 18/016,999

(22) PCT Filed: Jul. 28, 2021
(86) PCT No.: PCT/JP2021/027929

§ 371 Date: Jan. 19, 2023

(30) Foreign Application Priority Data
Jul. 29, 2020 (JP) 2020-127962

(51) Int. Cl. B66C 13/46; B66C 23/90

(52) U.S. Cl. CPC B66C 13/46; B66C 23/905; B66C 2700/084

(57) ABSTRACT

This dynamic lift-off control device, which is mounted on a crane having a boom and a winch for winding a wire rope and controls dynamic lift-off of a suspended load, comprises: an image-capturing unit that is installed at the tip of the boom and captures an image including a hook; and a control unit that controls a winding action of the winch and a raising action of the boom. The control unit calculates the amount of misalignment between the tip of the boom and the hook on the basis of the image, and feedback controls the raising of the boom to reduce the amount of misalignment, thereby suppressing the swing of the suspended load.

### TECHNICAL FIELD

The present invention relates to a dynamic lift-off control device and a mobile crane for suppressing a load swing when lifting a suspended load off the ground.

### BACKGROUND ART

Conventionally, in a crane including a boom, when a suspended load is lifted off the ground, that is, when the suspended load is removed from the ground, a work radius is increased due to deflection of the boom, so that a “load swing” that the suspended load swings in a horizontal direction has been a problem (see FIG. 1).

For the purpose of preventing a load swing at the time of lift-off, for example, a vertical lift-off control device described in Patent Literature 1 is configured to detect the rotation speed of the engine by an engine rotation speed sensor and correct the raising action of the boom to a value corresponding to the engine rotation speed.

### CITATION LIST

### Patent Literature

Patent Literature 1: JP 8-188379 A

### SUMMARY OF THE INVENTION

### Problems to be Solved by the Invention

Meanwhile, in the conventional dynamic lift-off control devices including Patent Literature 1, in order to keep the work radius constant, control is performed using a winch actuator and a derricking actuator in combination. Therefore, there is a problem that it takes time to perform dynamic lift-off due to complicated control.

Therefore, an object of the present invention is to provide a dynamic lift-off control device capable of promptly lifting the suspended load off the ground while suppressing a load swing, and a mobile crane including the dynamic lift-off control device.

### Solutions to Problems

One aspect of a dynamic lift-off control device according to the present invention, which is mounted on a crane having a boom and a winch for winding a wire rope and controls dynamic lift-off of a suspended load, includes: an image-capturing unit that is installed at the tip of the boom and captures an image including a hook; and a control unit that controls a winding action of the winch and a raising action of the boom.

The control unit calculates the amount of misalignment between the tip of the boom and the hook on the basis of the image, and performs feedback control of the raising of the boom to reduce the amount of misalignment, thereby suppressing the swing of the suspended load.

One aspect of the mobile crane according to the present invention includes the above-described dynamic lift-off control device.

### Effects of the Invention

According to the present invention, provided is a dynamic lift-off control device capable of promptly lifting the suspended load off the ground while suppressing a load swing, and a mobile crane including the dynamic lift-off control device.

### BRIEF DESCRIPTION OF DRAWINGS

FIG. 1 is an explanatory view for explaining a load swing of a suspended load.

FIG. 2 is a side view of a mobile crane.

FIG. 3 is a block diagram of a dynamic lift-off control device.

FIG. 4 is a block diagram of the entire dynamic lift-off control device.

FIG. 5 is a block diagram of lift-off control.

FIG. 6 is a flowchart of the lift-off control.

FIG. 7 is a graph for explaining a method of lift-off determination.

FIG. 8 is a graph illustrating a relationship between a load and a derricking angle.

FIG. 9 is a schematic view illustrating a situation of dynamic lift-off of the mobile crane.

FIG. 10A is an image of an image-capturing means at the time of dynamic lift-off.

FIG. 10B is an image of the image-capturing means at the time of dynamic lift-off.

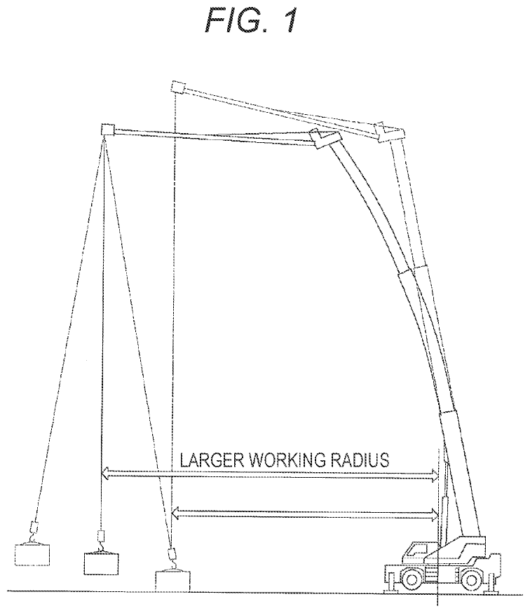

### DESCRIPTION OF EMBODIMENTS

Hereinafter, an example of an embodiment according to the present invention will be described with reference to the drawings. However, the components described in the following embodiments are merely examples, and the technical scope of the present invention is not limited thereto.

### EMBODIMENT

In the present embodiment, examples of a mobile crane include a rough terrain crane, an all terrain crane, and a truck crane. Hereinafter, a rough terrain crane will be described as an example of a work vehicle according to the present embodiment, but a dynamic lift-off control device according to the present invention can also be applied to other types of mobile cranes.

(Configuration of Mobile Crane)

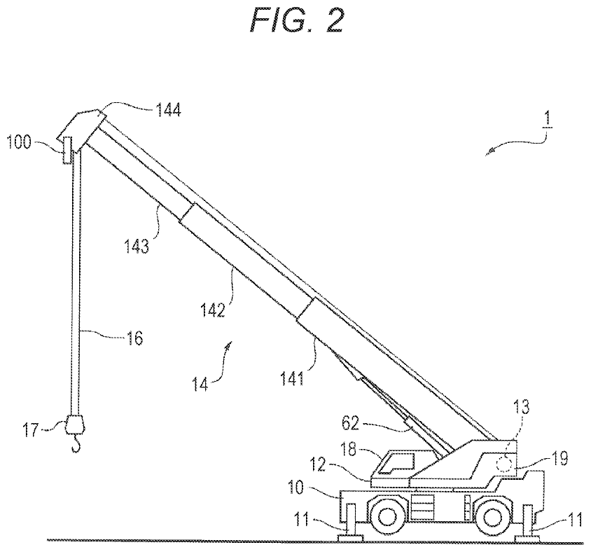

First, a configuration of the mobile crane will be described with reference to FIG. 2. As illustrated in FIG. 2, a rough terrain crane 1 according to the present embodiment includes a vehicle body 10 serving as a main body portion of a vehicle having a traveling function, outriggers 11 provided at four corners of the vehicle body 10, a turning table 12 attached to the vehicle body 10 so as to be horizontally turnable, and a boom 14 attached to the rear of the turning table 12.

The outrigger 11 can be slidably overhung from or slidably stored in the vehicle body 10 outside in the width direction by expanding and retracting a slide cylinder. In addition, the outrigger 11 can be jack-overhung from or jack-stored in the vehicle body 10 in the vertical direction by expanding and retracting a jack cylinder.

The turning table 12 includes a pinion gear to which power of a turning motor 61 is transmitted, and the pinion gear meshes with a circular gear provided on the vehicle body 10 to turn about a turning shaft. The turning table 12 includes an operator's seat 18 disposed on the right front side and a counterweight 19 disposed on the rear side.

Furthermore, a winch 13 for winding up and winding down a wire 16 is disposed behind the turning table 12. The winch 13 rotates in two directions of a winding up direction (winding direction) and a winding down direction (unwinding direction) by rotating a winch motor 64 in the forward direction or the reverse direction.

The boom 14 is configured in a telescopic manner by a base boom 141, an intermediate boom (or booms) 142, and a tip boom 143, and is expanded and retracting by a telescoping cylinder 63 disposed therein. A sheave is disposed on a boom head 144 at the most distal end of the tip boom 143, and the wire 16 is hung on the sheave to suspend a hook 17.

A proximal end portion of the base boom 141 is rotatably attached to a support shaft installed on the turning table 12. The base boom 141 can be derricked (raised and lowered) about the support shaft as a rotation center. A derricking cylinder 62 is stretched between the turning table 12 and the lower surface of the base boom 141. By extending and retracting the derricking cylinder 62, the entire boom 14 is derricked.

An image-capturing means 100, which is an example of an image-capturing unit, is attached to the boom head 144, for example, the distal end side of the boom head 144. The image-capturing means 100 photographs the lower side in the vertical direction from the boom head 144 at a wide angle. The image-capturing means 100 is, for example, an imaging element such as a CCD or a CMOS, a digital camera having an optical lens, or the like. The image-capturing means 100 is attached to the boom head 144 via a swing member such as a gimbal so as to be swingable at least in the derricking direction of the boom 14. The image-capturing means 100 faces vertically downward in the derricking direction.

Therefore, regardless of the derricking state (derricking angle) of the boom 14, the image-capturing means 100 captures an image including the hook 17 while facing vertically downward in the derricking direction of the boom 14.

(Configuration of Control System)

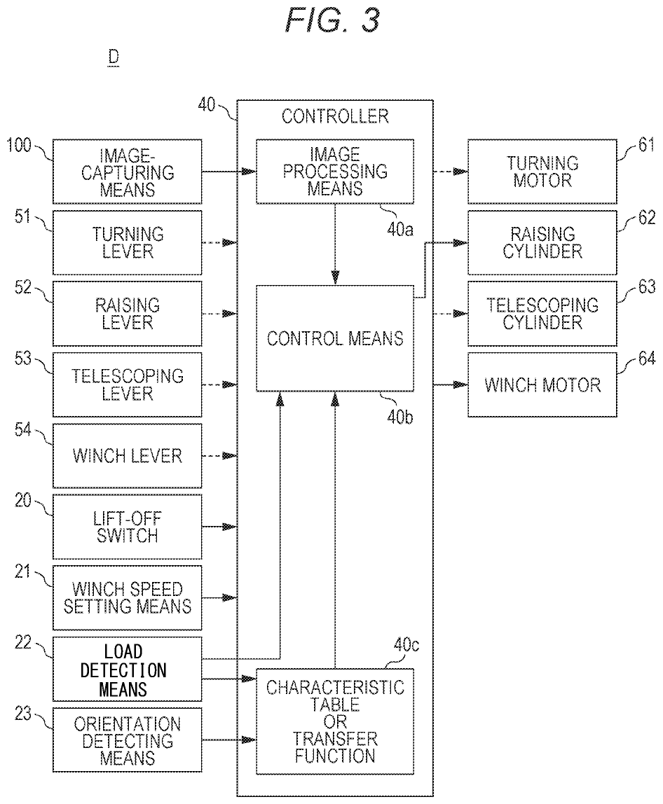

Next, a configuration of a control system of a dynamic lift-off control device D according to the present embodiment will be described with reference to the block diagram of FIG. 3. The dynamic lift-off control device D is mainly configured by a controller 40 as a control unit. The controller 40 is a general-purpose microcomputer including an input port, an output port, an arithmetic device, and the like.

The image-capturing means 100 attached to the boom head 144 is connected to the controller 40 according to the present embodiment. The controller 40 includes an image processing means 40a that processes an image received from the image-capturing means 100.

In addition, the controller 40 according to the present embodiment receives an operation signal from operation levers 51 to 54 (a turning lever 51, a derricking lever 52, a telescoping lever 53, and a winch lever 54), and controls the turning motor 61, the derricking cylinder 62, the telescoping cylinder 63, and the winch motor 64, which are actuators, via an unillustrated control valve.

Furthermore, the controller 40 according to the present embodiment is connected with a lift-off switch 20 for starting or stopping the dynamic lift-off control, a winch speed setting means 21 for setting the speed of the winch 13 in the dynamic lift-off control, a load detection means 22 for detecting a load acting on the boom 14, and an orientation detection means 23 for detecting the orientation of the boom 14.

The lift-off switch 20 is an input device for instructing to start or stop the dynamic lift-off control, and may be configured to be added to a safety device of the rough terrain crane 1, for example. Preferably, the lift-off switch 20 is provided at the operator's seat 18.

The winch speed setting means 21 is an input device that sets the speed of the winch 13 in the dynamic lift-off control. The winch speed setting means 21 has a method of selecting an appropriate speed from preset speeds, and a method of inputting with a numeric keypad. Further, the winch speed setting means 21 may be configured to be added to the safety device of the rough terrain crane 1, similarly to the lift-off switch 20. Preferably, the winch speed setting means 21 is provided at the operator's seat 18. The time required for the dynamic lift-off control can be adjusted by adjusting the speed of the winch 13 by the winch speed setting means 21.

The load detection means 22 is a detection device that detects a load acting on boom 14. The load detection means 22 may be, for example, a pressure gauge that detects the pressure acting on the derricking cylinder 62. A signal related to the detection value (for example, the pressure value) detected by the load detection means 22 (for example, a pressure gauge) is transmitted to the controller 40.

The orientation detection means 23 is a detection device that detects the orientation of the boom 14. The orientation detection means 23 includes a derricking angle meter 231 that detects a derricking angle of the boom 14 and a derricking angular speed meter 232 that detects a derricking angular speed. More specifically, the derricking angle meter 231 is, for example, a potentiometer. Further, the derricking angular speed meter 232 is a stroke sensor attached to the derricking cylinder 62. A derricking angle signal detected by the derricking angle meter 231 and a derricking angular speed signal detected by the derricking angular speed meter 232 are transmitted to the controller 40.

The controller 40 is a control unit that controls operations of the boom 14 and the winch 13. When the lift-off switch 20 is turned on, the controller 40 perform an winding action by the winch 13 to start the suspended load lift-off action. In the lift-off action, the controller 40 calculates a misalignment amount (for example, the displacement amount in the horizontal direction) between the distal end of boom 14 and the center of hook 17 on the basis of the image captured by image-capturing means 100. Then, controller 40 causes the boom 14 to be derricked (raised/lowered) so as to set the calculated misalignment amount to zero. In this manner, the controller 40 suppresses the swing of the suspended load. Such control executed by the controller 40 is feedback control (FB control). In parallel with the FB control, the controller 40 predicts a change amount of the derricking angle of the boom 14 based on a temporal change of the load detected by the load detection means 22. Then, the controller 40 derricks (raises/lowers) the boom 14 to compensate for the predicted change amount. Such control executed by the controller 40 is feedforward control (FF control).

More specifically, the controller 40 includes, as functional units for performing the FB control and the FF control, the image processing means 40a that is an image processing unit for processing an image transmitted from the image-capturing means 100, a selection function unit 40c for selecting a characteristic table or a transfer function, and a control unit 40b that controls the operation of the entire crane and performs lift-off determination for stopping the dynamic lift-off control by determining whether or not the dynamic lift-off has actually performed.

The image processing means 40a also functions as a misalignment amount calculation unit that calculates a misalignment amount between the tip of the boom 14 and the center of the hook 17. Such an image processing means 40a first performs edge detection on the image transmitted from the image-capturing means 100. Then, the image processing means 40a performs Hough transform of a predetermined shape (for example, a circular shape) on the basis of the information regarding the detected edge, and extracts a shape from the image (hereinafter, the shape is referred to as an extracted shape). Then, the image processing means 40a extracts the upper surface shape of the hook 17 from the extracted shape. Specifically, the image processing means 40a extracts the most appropriate shape as the upper surface shape of the hook 17 from the extracted shapes based on the lifting information of the crane and the shape information of the hook as the upper surface shape of the hook 17. Then, the center point of the extracted upper surface shape of the hook 17 is set as the center of gravity of the hook 17.

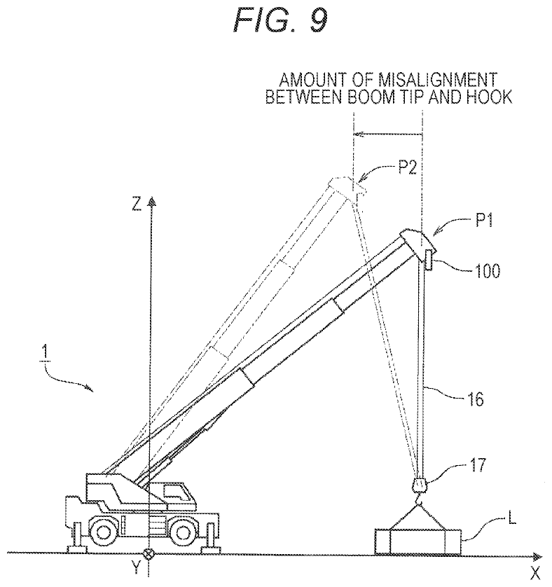

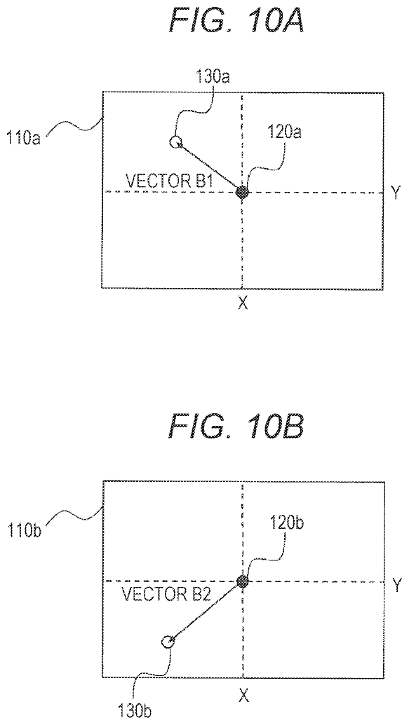

Next, as illustrated in an image 110a (see FIG. 10A) captured by the image-capturing means 100, the image processing means 40a calculates a vector B1 from the image center 120a to the center of gravity 130a of the hook 17 in the image coordinate system. According to the present embodiment, the image-capturing means 100 is swingably attached to the boom head 144 via a swing member such as a gimbal, and always faces vertically downward (directly below). Further, as indicated by a solid line in FIG. 9, since the tip of the boom 14 is right above the suspended load at the end of slinging work, the vector B1 is a vector (initial value) corresponding to a state in which the amount of misalignment between the tip of the boom 14 and the center of the hook 17 in the horizontal direction is zero. Hereinafter, the vector B1 may also be referred to as an initial value vector B1. The image processing means 40a calculates a vector from the image center in the image coordinate system to the center (center of gravity) of the hook 17 for each calculation cycle. Therefore, when the boom tip moves in the raising direction as indicated by a broken line in FIG. 9, a vector B2 from the image center 120b to the center of gravity 130b of the hook 17 in the image coordinate system is calculated (see an image 110b in FIG. 10B). Then, the image processing means 40a calculates an angle formed by the calculated vector B2 and the initial value vector B1 as an amount of misalignment between the tip of the boom 14 and the center of the hook 17. FIG. 9 is a view for describing a concept of an amount of misalignment between the tip of the boom 14 and the center of the hook 17, and is not a view illustrating a state of the boom 14 in the dynamic lift-off control.

In the dynamic lift-off control, the controller 40 controls the derricking cylinder 62 to raise the boom 14 so that the calculated amount of misalignment becomes zero (feedback (FB) control). In the above example, the configuration in which the image processing means 40a also serves as the misalignment amount calculation unit that calculates the misalignment amount between the tip of the boom 14 and the center of the hook 17 has been described. However, the misalignment amount calculation unit and the image processing means 40a may be provided separately, for example, the control unit 40b may also serve as the misalignment amount calculation unit.

In the above description, an example has been described in which the image-capturing means is swingably attached to the boom head 144 via a swing member such as a gimbal and always faces downward in the vertical direction, but the present invention is not limited in this respect. For example, the image-capturing means 100 may be fixed to the boom head 144 so as not to be swingable, that is, the direction of the image-capturing means 100 may be changed according to the derricking of the boom head 144. In this case, the image processing means 40a matches the center of the image in the image coordinate system with the center of gravity of the hook 17 in the image captured by the image-capturing means 100. Then, in a case where the image-capturing means 100 faces directly downward, the derricking cylinder 62 is controlled so that the center of gravity of the hook 17 coincides with the image center in the image coordinate system (that is, the amount of misalignment becomes zero). On the other hand, when the image-capturing means 100 does not face directly downward due to the raising of the boom 14, the image-capturing means 100 tracks the center of gravity of the target hook 17. Then, the controller 40 calculates a corrected derricking angle from the angle of the image-capturing means and the derricking angle of the boom 14 at that time, and controls the derricking cylinder 62 based on the calculated derricking angle.

The characteristic table/transfer function selection function unit 40c acquires an initial value of a detection value (for example, the pressure value) of the load detection means 22 (for example, a pressure gauge) and an initial value of a detection value (for example, the derricking angle) of the orientation detection means 23 (for example, a derricking angle meter), and determines the characteristic table or transfer function to be applied based on the acquired initial value of the detection value of the load detection means 22 and the initial value of the detection value of the orientation detection means 23. Here, as the transfer function, a relationship using a linear coefficient a can be applied as follows.

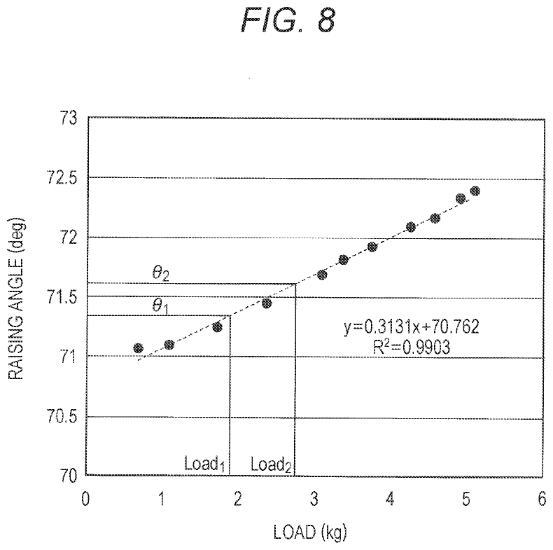

First, as illustrated in the load/derricking angle graph of FIG. 8, it is found that the load and the derricking angle (tip-to-ground angle) have a linear relationship when the boom tip position is adjusted to be always directly above the suspended load not to cause the load swing. Assuming that the load Load₁ changes to Load₂ during the dynamic lift-off from time t₁ to time t₂, the relationship between the derricking angle θ and the load Load, the relationship between the derricking angle θ₁ and the load Load₁, and the relationship between the derricking angle θ₂ and the load Load₂ are expressed by the following equations.

θ=a·Load+b Approximate expression

t₁ θ₁=a·Load₁+b

t₂ θ₂=a·Load₂+b [Math. 1]

The difference between the two equations is expressed by the following equation by a difference equation.

θ₂−θᵢ=a(Load₂−Load₁)

Δθ=a·ΔLoad [Math. 2]

In order to control the derricking angle, it is necessary to give a derricking angular speed represented by the following equation.

$${V}_{Drv} = \frac{Δθ}{( {t}_{2} - {t}_{1} )} = a \cdot \frac{Δ Load}{Δ t} = a \cdot {L}_{Load} \qquad [ Math . 3 ]$$

Here, a is a constant (linear coefficient). In other words, in the derricking angle control, the temporal change (differential) of the load is input.

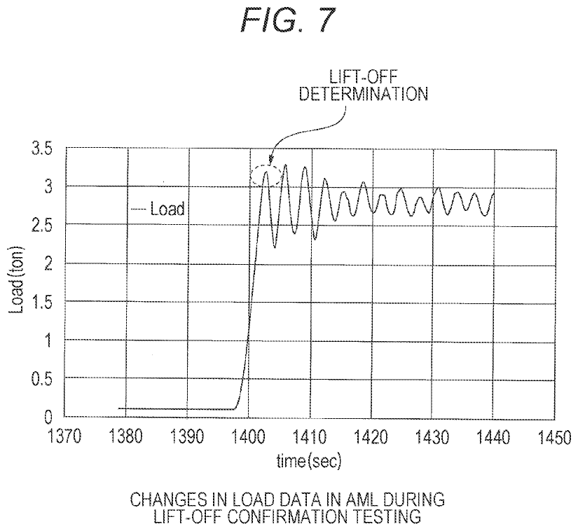

The control unit 40b monitors the amount of misalignment between the tip of the boom 14 and the center of the hook 17 calculated by the image processing means 40a, and also functions as a lift-off determination means that monitors time-series data of the load value calculated based on the detection value (for example, the pressure signal) of the load detection means 22 (for example, a pressure gauge) to determine whether the dynamic lift-off has been performed. A method of the lift-off determination will be described later with reference to FIG. 7.

(Overall Block Diagram)

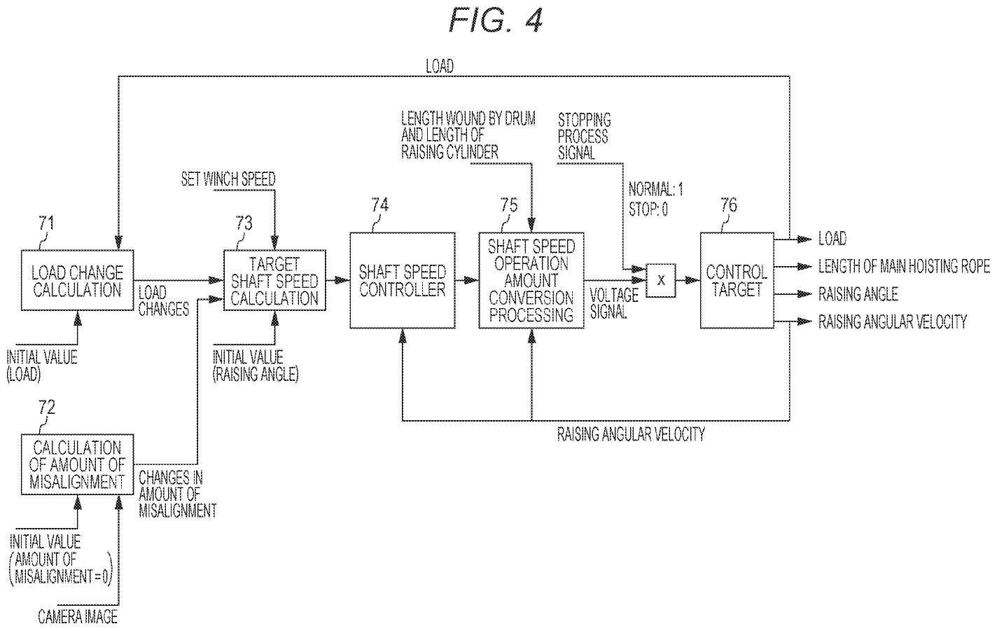

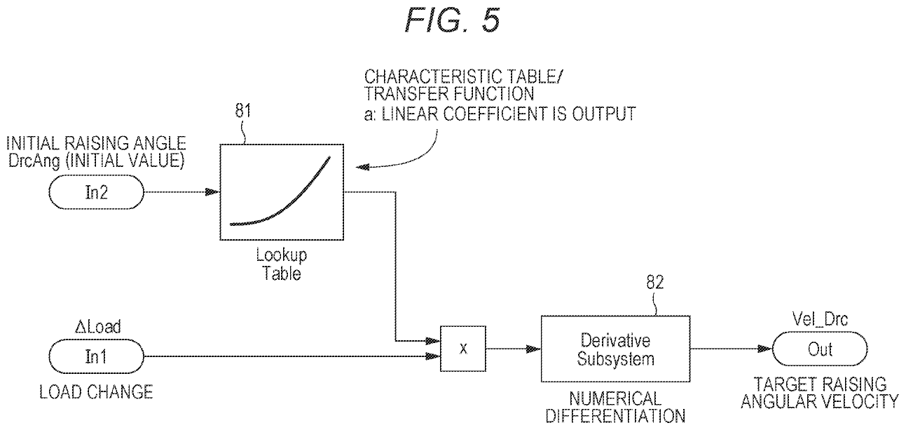

Next, with reference to a block diagram of FIG. 4, an input/output relationship among all elements including the dynamic lift-off control according to the present embodiment will be described in detail. First, a load change calculation unit 71 calculates a load change based on time-series data of a load detected by load detection means 22. The calculated load change is input to a target shaft speed calculation unit 73 for feedforward (FF) control. An input/output relationship of the target shaft speed calculation unit 73 in the feedforward (FF) control will be described later with reference to FIG. 5.

A misalignment amount calculation unit 72 calculates the misalignment amount between the tip of the boom 14 and the center of the hook 17. The calculated misalignment amount is input to the target shaft speed calculation unit 73 for feedback (FB) control.

The target shaft speed calculation unit 73 calculates the target shaft speed based on the initial value of the derricking angle, the set winch speed, the input amount of misalignment change, and the input load change (load change with time). Here, the target shaft speed is a target derricking angular speed (and, although not required, the target winch speed). The calculated target shaft speed is input to a shaft speed controller 74. The control of the first half up to this point is processing related to the dynamic lift-off control according to the present embodiment.

Thereafter, the operation amount is input to a control target 76 via the shaft speed controller 74 and a shaft speed operation amount conversion processing unit 75. The control of the latter half is processing related to normal control, and is feedback-controlled based on the detected derricking angular speed.

(Block Diagram of Feedforward Control)

Next, an input/output relationship of elements in the target shaft speed calculation unit 73 of feedforward control in particular will be described with reference to the block diagram of FIG. 5. First, an initial value of the derricking angle is input to a characteristic table/transfer function selection function unit 81 (40c). In the selection function unit 81, the most appropriate constant (linear coefficient) a is selected using the characteristic table (LookupTable) or the transfer function (equation).

Then, numerical differentiation (differentiation with respect to time) of the load change is performed in a numerical differentiation unit 82, and the target derricking angular speed is calculated by multiplying the result of the numerical differentiation by the constant a. That is, the target derricking angular speed is calculated by executing the calculation of (Equation 3) described above. As described above, the control of the target derricking angular speed is feedforward controlled using the characteristic table (or the transfer function).

(Flowchart)

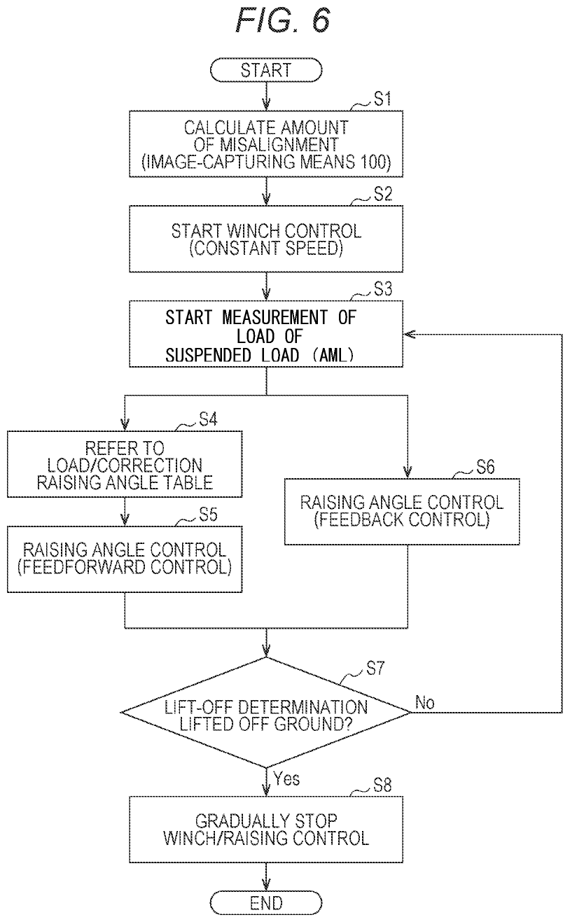

Next, the overall flow of the dynamic lift-off control according to the present embodiment will be described with reference to the flowchart of FIG. 6.

First, the suspended load is hung, and in a state where the boom tip is right above the suspended load, an operator presses the lift-off switch 20 to start the dynamic lift-off control (START). At this time, the target speed of the winch 13 is previously set via the winch speed setting means 21 before or after the start of the dynamic lift-off control. This target speed is, for example, a constant speed.

Then, by image processing, by the image processing means 40a, of the image captured by the image-capturing means 100, measurement of the vector from the image center to the hook center is started (step S1). In other words, in step S1, detection of the misalignment amount is started. At this time, the initial value of the vector is a vector from the image center to the hook center in a state where the boom tip is right above the suspended load. Note that the direction of the vector is not limited to the direction from the image center to the hook center, and may be a direction from the hook center to the image center.

Next, the controller 40 starts winch control at the target speed (step S2).

Then, at the same time as the winch 13 is wound up, the suspended load detection by the load detection means 22 is started, and the load value is input to the controller 40 (step S3). Then, the selection function unit 40c receives the input of the initial value of the load and the initial value of the derricking angle from the orientation detection means 23 (for example, a derricking angle meter), and determines the characteristic table or the transfer function to apply (step S4).

Next, the controller 40 calculates the derricking angle based on the applied characteristic table or transfer function and the load change (step S5). In other words, the derricking angle control is performed by the feedforward control.

In parallel with steps S4 and S5, the derricking angle control is performed by feedback control (step S6). In the derricking angle control, as described above, the angle formed by the vector calculated in step S1 and the initial value vector is calculated. This formed angle is calculated as a misalignment amount between the tip of the boom 14 and the center of the hook 17. The controller 40 controls the derricking cylinder 62 to raise the boom 14 so that the calculated amount of misalignment becomes zero.

Then, whether the dynamic lift-off has been performed is determined based on the time-series data of the detected load and the misalignment amount between the tip of the boom 14 and the center of the hook 17 (step S7). The determination method will be described later. As a result of the determination, when the dynamic lift-off has not been performed (NO in step S7), the process returns to step S2, and the feedforward control based on the load and the feedback control based on the misalignment amount are repeated (steps S2 to S6).

As a result of the determination, when the dynamic lift-off has been performed (YES in step S7), the dynamic lift-off control is gradually stopped (step S8). In other words, the dynamic lift-off control is stopped while reducing the rotational driving speed of the winch 13 by the winch motor and reducing the derricking driving speed by the derricking cylinder 62.

(Lift-Off Determination)

Next, a method of the lift-off determination according to the present embodiment will be described with reference to the graph of FIG. 7. According to the present embodiment, while the winch 13 is acting an winding action in the dynamic lift-off control, the controller 40 monitors the time-series data of the misalignment amount between the tip of the boom 14 and the center of the hook 17 and the detected load, and when the misalignment amount is equal to or less than a threshold value or zero, captures a first maximum value of the time series data to determine that the dynamic lift-off has been performed.

More specifically, as illustrated in FIG. 7, in general, when taking a time series of load data, the load data overshoots at the next moment after the dynamic lift-off, then undershoots, and transitions to continue to vibrate. Therefore, it is possible to determine whether the dynamic lift-off has been performed by capturing the time of the peak of the first peak of vibration, that is, the first maximum value. However, actually, at the time when the first maximum value is recorded, which is the time when it is determined that the dynamic lift-off has been performed, it is considered that the data slightly overshoots due to the inertial force.

(Effects)

Next, effects obtained by the dynamic lift-off control device D according to the present embodiment will be listed and described.

(1) As described above, the dynamic lift-off control device D according to the present embodiment includes a boom that is configured to be derrickable, an image-capturing means that is attached to a tip of the boom and captures an image vertically downward, a winch that winds up or down a hook and a suspended load via a wire attached to the hook, and a control unit controls the boom and the winch. When the suspended load is lifted off the ground by winding up the winch, the control unit calculates a vector from a tip of the boom and the center of the hook on the basis of the image captured by the image-capturing means and causes the boom to raise on the basis of the vector. With this configuration, the dynamic lift-off control device D can promptly lift off the suspended load from the ground while suppressing the swing of the load.

In other words, the dynamic lift-off control device D according to the present embodiment can promptly lift the suspended load off the ground by performing feedback control so as to cancel an amount of misalignment between the tip position of the boom and the center of gravity of the suspended load based on the image captured by the image-capturing means that captures an image vertically downward, that is, to make the tip of the boom always being placed right above the suspended load.

(2) Further, in the dynamic lift-off control device D, when lifting the suspended load off the ground by the winding action by the winch, the controller 40 obtains a change amount of the derricking angle of the boom based on the detected temporal change of the load and causes the boom to raise so as to compensate the change amount. At this time, the controller 40 selects the corresponding characteristic table or the transfer function on the basis of the initial value of the orientation of the boom detected by the orientation detection means that detects the orientation of the boom and the initial value of the detected load. Then, the controller 40 obtains the change amount of the derricking angle of the boom from the temporal change of the detected load using the selected characteristic table or the transfer function. With this configuration, at the start of the dynamic lift-off control, the winch 13 is wound up at a constant speed, and the derricking angle control amount is calculated from the characteristic table (or the transfer function) in accordance with the load change to perform the feedforward control, so that the dynamic lift-off can be promptly performed without the load swing. In addition, since the number of parameters to be adjusted is reduced, adjustment at the time of shipment can be quickly and easily performed.

(3) In the feedforward control, there is a problem that an error factor such as an individual difference between characteristic data of a load and a derricking angle, a change in oil temperature characteristic, or a disturbance influence cannot be coped with. However, by using the feedback control according to the present embodiment, it is possible to automatically perform dynamic lift-off without a load swing even in a case where there is an individual difference or an oil temperature fluctuation of each product.

(4) Furthermore, when lifting the suspended load off the ground by the winding action by the winch, in the dynamic lift-off control device D is preferably configured to perform an winding action by the winch at a constant speed. With this configuration, the influence of the disturbance such as the inertial force is suppressed, and the response (detected load value) is stabilized, so that the lift-off determination can be easily performed.

(5) In addition, when lifting the suspended load off the ground by the winding action by the winch, the dynamic lift-off control device D is preferably configured to adjust the time required for the dynamic lift-off by adjusting the speed of the winch. With this configuration, it is possible to work safely and efficiently by selecting an appropriate winch speed according to the weight of the suspended load and the environmental conditions.

(6) Furthermore, when lifting the suspended load off the ground by the winding action by the winch, the dynamic lift-off control device D according to the present embodiment monitors time-series data of the detected load and determines that the lifting off is performed by capturing the first maximum value in the time-series data. By performing the control based only on the load in this manner, it is possible to easily and quickly determine whether the dynamic lift-off has been performed.

(7) In addition, the rough terrain crane, which is the mobile crane of the present embodiment, is provided with any of the above-described dynamic lift-off control devices D, and thus becomes a rough terrain crane capable of quickly lifting the suspended load off the ground while suppressing the load swing.

Although the embodiment of the present invention has been described in detail with reference to the drawings, the specific configuration is not limited to this embodiment, and a design change that does not depart from the gist of the present invention is included in the present invention.

For example, although not specifically described in the embodiment, the dynamic lift-off control device D according to the present invention can be applied to both the case of performing the dynamic lift-off using a main winch as the winch and the case of performing the dynamic lift-off using a sub winch.

The entire disclosure of the specification, drawings, and abstract included in Japanese Patent Application No. 2020-127962 filed on Jul. 29, 2020 is incorporated herein by reference.

### INDUSTRIAL APPLICABILITY

The dynamic lift-off control device according to the present invention can be applied to various mobile cranes.

### REFERENCE SIGNS LIST

D Dynamic lift-off control device
a Linear coefficient
1 Rough terrain crane
10 Vehicle body
12 Turning table
13 Winch
14 Boom
16 Wire
17 Hook
20 Lift-off switch
21 Winch speed setting means
22 Pressure gauge (load detection means)
23 Derricking angle meter (orientation detection means)
40 Controller
40a Image processing means
40b Control unit
40c Selection function unit (characteristic table or transfer function)
51 Turning lever
52 Derricking lever
53 Telescoping lever
54 Winch lever
61 Turning motor
62 Derricking cylinder
63 Telescoping cylinder
64 Winch motor
100 Image-capturing means

1. A dynamic lift-off control device that is mounted on a crane having a boom and a winch for winding a wire rope supporting a hook, and that controls dynamic lift-off of a suspended load, the dynamic lift-off control device comprising:
an image-capturing unit that is installed at a tip of the boom and captures an image including the hook; and
a control unit that controls a winding action of the winch and a raising action of the boom,
wherein the control unit calculates an amount of misalignment between the tip of the boom and the hook on the basis of the image, and performs feedback control of the raising of the boom to reduce the amount of misalignment, thereby suppressing a swing of the suspended load.

2. The dynamic lift-off control device according to claim 1, wherein, together with the feedback control, the control unit performs feedforward control of the raising of the boom by estimating a change amount of a derricking angle of the boom on the basis of a temporal change of the load and compensating the change amount of the estimated derricking angle.

3. The dynamic lift-off control device according to claim 2, wherein the control unit
selects a table or an equation for estimating the change amount of the derricking angle on the basis of an initial value of the derricking angle of the boom and an initial value of the load, and
estimates the change amount of the derricking angle on the basis of the temporal change of the load and the selected table or equation.

4. The dynamic lift-off control device according to claim 1, wherein the image-capturing unit always faces vertically downward.

5. The dynamic lift-off control device according to claim 1, wherein the control unit calculates a vector that connects the tip of the boom and a center of the hook in the image and calculates the amount of misalignment on the basis of the calculated vector.

6. The dynamic lift-off control device according to claim 1, further comprising
a load detection unit that detects load that acts on the boom,
wherein the control unit determines that the dynamic lift-off has been completed when detecting a first maximum value of detection values in the load detection unit.

7. The dynamic lift-off control device according to claim 1, wherein the control unit controls the winch to act the winding action at a constant speed in the dynamic lift-off control.

8. A mobile crane comprising the dynamic lift-off control device according to claim 1.
